(19) United States
(12) Patent Application Publication
(10) Pub. No.: US 2026/0112024 A1
(43) Pub. Date: Apr. 23, 2026

(54) BATTERY MANUFACTURING SYSTEM AND MANUFACTURING METHOD THEREOF

(71) Applicant: SK On Co., Ltd., Seoul (KR)

(72) Inventors: Jae Young JUNG, Daejeon (KR); Kyeung Su SHIN, Daejeon (KR); Nam Il AN, Daejeon (KR); Bong Kun CHO, Daejeon (KR); Woo Yeon CHO, Daejeon (KR)

(21) Appl. No.: 19/366,513

(22) Filed: Oct. 23, 2025

(30) Foreign Application Priority Data
Oct. 23, 2024 (KR) 10-2024-0145879

(51) Int. Cl. G06T 7/00; G01N 21/88; G06T 7/12; G06T 7/62; G06V 10/145; G06V 10/20; H01M 10/04

(52) U.S. Cl. CPC G06T 7/001; G01N 21/8806; G06T 7/12; G06T 7/62; G06V 10/145; G06V 10/255; H01M 10/0404; G06T 2207/30164; G06V 2201/07

(57) ABSTRACT

The present disclosure relates to a battery manufacturing system for manufacturing a battery cell including an electrode assembly in which a plurality of electrodes are stacked, and may include a vision device for inspecting a foreign object disposed on the electrodes, wherein the vision device may include a moving unit, a shooting unit, an illuminating unit, and a controller.

### CROSS-REFERENCE TO RELATED PATENT APPLICATION

The present application claims priority under 35 U.S.C. § 119a to Korean patent application number 10-2024-0145879 filed on Oct. 23, 2024, in the Korean Intellectual Property Office, the entire disclosure of which is incorporated by reference herein.

### BACKGROUND OF THE DISCLOSURE

### 1. Field

This disclosure relates to a battery manufacturing system and a manufacturing method thereof.

### 2. Description of the Related Art

In general, an electrode manufacturing apparatus can manufacture roll-shaped electrodes according to a standard, and the standard of the electrodes can vary depending on the shape of the secondary battery. Cylindrical and prismatic batteries may be manufactured with an elongated width of the electrode so that a winding electrode assembly may be inserted inside. Pouch batteries may be manufactured with shorter widths of electrodes, and stacked electrode assemblies may be inserted inside.

The electrode manufacturing apparatus may generate foreign object such as electrode fragments during the cutting of the electrode to manufacture the electrode to a specification. The generated foreign object may be disposed on the surface of the electrode, but currently, there is a problem that the surface of the electrode is not inspected for foreign object before the electrode assembly is generated, and the electrode assembly is manufactured with foreign object disposed on the surface of the electrode.

According to one aspect of the present disclosure, an object is to provide early detection of foreign object disposed on the surface of an electrode.

According to another aspect of the present disclosure, an object is to determine whether foreign object generated in an electrode manufacturing apparatus is disposed on the surface of an electrode.

According to another aspect of the present disclosure, an object is to determine if foreign object is disposed on the surface of an electrode prior to lamination of the electrode.

According to another aspect of the present disclosure, an object is to analyze an image to determine the boundaries of the surface shape of the electrode.

According to another aspect of the present disclosure, an object is to determine the location of the foreign object on the surface of the electrode.

According to another aspect of the present disclosure, an object is to detect a foreign object of a certain size or larger.

According to another aspect of the present disclosure, an object is to improve the performance of an electrode assembly manufactured in a battery manufacturing system.

According to another aspect of the present disclosure, an object is to improve the performance of a battery cell comprising an electrode assembly.

According to another aspect of the present disclosure, an object is to improve the safety of a battery manufacturing system that manufactures battery cells.

The battery manufacturing system according to the present disclosure may be widely applied in the fields of electric vehicles, battery charging stations, energy storage systems, and other green technologies such as photovoltaics and wind power utilizing batteries. Furthermore, the battery cells according to the present disclosure may be used in eco-friendly Mobility, including electric and hybrid vehicles to prevent climate change by suppressing air pollution and greenhouse gas emissions.

### SUMMARY OF THE DISCLOSURE

A battery manufacturing system according to an embodiment of the present disclosure may comprise: a vision device for inspecting a foreign object disposed on an electrode, wherein the vision device may include: a moving unit supporting the electrode and moving it to a shooting location; a shooting unit positioned above the moving unit and shooting the surface of the electrode positioned at the shooting location; an illuminating unit irradiating light into an illumination region formed larger than shooting location; and a controller analyzing a shot image obtained by the shooting unit and determining and detecting a foreign object disposed on the surface of the electrode when the electrode is positioned in the illumination region.

In an embodiment, the controller, before determining whether the foreign object is disposed on the surface of the electrode, may analyze the shot image to determine a boundary of the shape of the electrode surface.

In an embodiment, the illuminating unit may include a plurality of light sources and the plurality of light sources are arranged along a direction of movement of the electrode and a direction perpendicular to the direction of movement, and illuminate the boundary.

In an embodiment, a length between the light sources arranged in the direction perpendicular to the direction of movement may be longer than a length of the electrode extending along a direction perpendicular to the direction of movement.

In an embodiment, the controller may derive an inner region image of an inner region of the electrode corresponding to an interior of the boundary from the shot image, and determines whether the foreign object is disposed in the inner region image.

In an embodiment, the controller may convert the pixels of the inner region image into numeral values, and determines that the foreign object is disposed in a pixel having a reference value or higher among the pixels.

In an embodiment, the controller may distinguish the foreign object from the surface of the electrode by adjusting the brightness or contrast of pixels having the reference value or higher, and determines an area of the appearance of the foreign object.

In an embodiment, the controller may determine that the foreign object is a target for detection when the area of the appearance of the foreign object is equal to or higher than a detection value.

In an embodiment, the detection value may correspond to an area formed by 5 mm in width and 5 mm in length.

In an embodiment, the controller may determine that the foreign object is disposed at the boundary when a length of a direction of movement of the electrode and a length of a direction perpendicular to the direction of movement of the electrode with respect to an inner region of the electrode differs by more than a design value and a boundary value.

In an embodiment, the boundary value may correspond to a length of 3 mm.

In an embodiment, the illuminating unit may include: a first light and a second light spaced upwardly from the moving unit and arranged in the direction of movement of the electrode, a third light and a fourth light spaced upwardly from the moving unit and arranged in the direction perpendicular to the direction of movement of the electrode, and wherein the first, second, third, and fourth lights may be connected to form the illumination region.

In an embodiment, the shooting unit may be provided in plural and the plurality of the shooting units each shoot an area of the illumination region.

In an embodiment, the illuminating unit may include a lower illuminating unit arranged downwardly spaced apart from the moving unit.

A battery manufacturing method according to another embodiment of the present disclosure using a battery manufacturing system including a vision device moving an electrode through a moving unit and inspecting it through a shooting unit, the method may comprise: a step of moving the electrode through the moving unit to position the electrode in an illumination region, a step of shooting the electrode through the shooting unit to obtain a shot image of the electrode, and a step of detecting a foreign object on a surface of the electrode based on the shot image.

In another embodiment, the step of detecting a foreign object may include: a step of determining whether the foreign object is disposed based on a pixel number value of an image of an inner region of a boundary of a shape of the electrode surface obtained from the shot image and a step of determining, if the foreign object is disposed, the foreign object is a target for detection based on the brightness or contrast of the image of the inner region.

In another embodiment, the step of determining whether the foreign object is disposed may include a step of determining that the foreign object is disposed at the boundary when the difference between a length of the electrode measured based on the pixel number value of the image of the inner region and a design number value is equal to or higher than a boundary number value.

In another embodiment, the step of determining whether the foreign object is disposed may include a step of determining that the foreign object is disposed in the inner region when pixel number value is equal to or higher than a preset reference value based on the pixel number value of the image of the inner region.

In another embodiment, the step of determining whether the foreign object is disposed may include a step of calculating a size of the foreign object disposed in the inner region or at the boundary based on the brightness or contrast of the image of the inner region and a step of determining the foreign object as a target for detection when the calculated size is higher than a preset detection value or the preset reference value.

According to an embodiment of the present disclosure, it is possible to detect foreign objects disposed on the surface of an electrode early.

According to an embodiment of the present disclosure, it is possible to determine whether foreign object generated in an electrode manufacturing apparatus is disposed on the surface of an electrode.

According to an embodiment of the present disclosure, the presence of foreign object on the surface of an electrode may be determined prior to lamination of the electrode.

According to an embodiment of the present disclosure, the boundaries of the surface morphology of the electrode may be identified by analyzing the shot image.

According to an embodiment of the present disclosure, the location of the foreign object on the surface of the electrode may be determined.

According to an embodiment of the present disclosure, a foreign object of a certain size or larger may be detected.

According to an embodiment of the present disclosure, the performance of an electrode assembly manufactured in a battery manufacturing system may be improved.

According to an embodiment of the present disclosure, the performance of a battery cell manufactured in a battery manufacturing system may be improved.

According to an embodiment of the present disclosure, a problem is to improve the safety of a battery manufacturing system that manufactures battery cells.

### BRIEF DESCRIPTION OF THE DRAWINGS

FIG. 1 is an exploded view of a battery cell including an electrode assembly manufactured in a battery manufacturing system according to an embodiment of the present disclosure.

FIG. 2 illustrates a process in which an electrode is manufactured in an electrode manufacturing apparatus of a battery manufacturing system according to an embodiment of the present disclosure.

FIG. 3 is a perspective view of a process of inspecting an electrode in a vision device of a battery manufacturing system according to an embodiment of the present disclosure.

FIG. 4 is a side view of a process of inspecting an electrode in a vision device of a battery manufacturing system according to an embodiment of the present disclosure.

FIG. 5 is a top view of a process of inspecting electrodes in a vision device of a battery manufacturing system according to an embodiment of the present disclosure.

FIG. 6 illustrates identifying the boundaries of an electrode in a vision device of a battery manufacturing system according to an embodiment of the present disclosure.

FIG. 7 illustrates a vision device of a battery manufacturing system according to an embodiment of the present disclosure showing a foreign object disposed at the boundary of an electrode.

FIG. 8 illustrates a foreign object disposed in an inner region of an electrode in a vision device of a battery manufacturing system according to an embodiment of the present disclosure.

FIG. 9 is a flow chart illustrating a battery manufacturing method according to an embodiment of the present disclosure.

### DETAILED DESCRIPTION

Hereinafter, the present disclosure will be described in detail with reference to the accompanying drawings. However, this is by way of example only and the present disclosure is not limited to the specific embodiment described in the example.

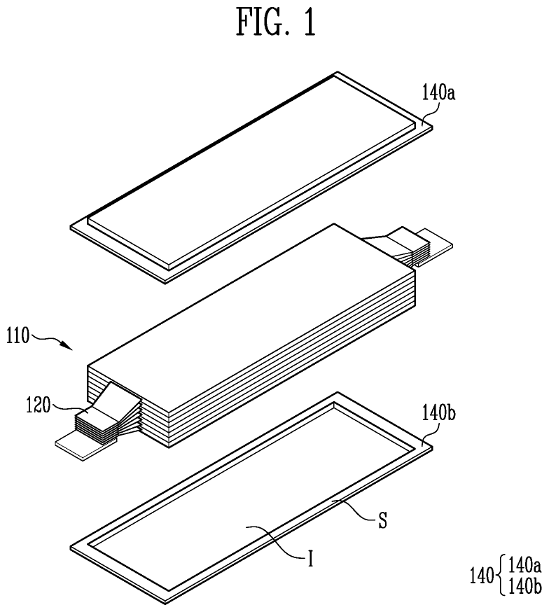

FIG. 1 is an exploded view of a battery cell including an electrode assembly manufactured in a battery manufacturing system according to an embodiment of the present disclosure.

Referring to FIG. 1, an electrode assembly 110 manufactured in a battery manufacturing system according to an embodiment of the present disclosure may be combined with an outer shell to form a battery cell.

The electrode assembly 110 may be in the form of one or more anodes and one or more cathodes disposed with a separator between them. The separator may be located between the anode and cathode.

For example, the electrode assembly 110 may have a stacked structure of alternating anodes and cathodes with a separator between them.

The outer shell material 140 may protect internal elements, such as the electrode assembly 110. For example, the outer shell material 140 may comprise an outer insulating layer, a metal layer, and an inner adhesive layer. The outer shell material 140 may be a flexible material, such as a film.

The outer shell material 140 may include an upper outer shell material 140a and a lower outer shell material 140b, and at least one of the upper outer shell material 140a and the lower outer shell material 140b may have a concave-shaped inner space formed therein. The inner space I may receive the electrode assembly 110.

A sealing portion S may be formed on the outer peripheral surface of the upper outer shell material 140a and the lower outer shell material 140b. The sealing portions S, which are bonded together, such as by adhesion, may seal the inner space I in which the electrode assembly 110 is received.

For example, when the electrode assembly 110 is received in the inner space I of the upper outer shell material 140a and the lower outer shell material 140b, sealing portions S may be formed on the four outer peripheral surfaces of the lower outer shell material 140b that abut the upper outer shell material 140a.

Alternatively, a sealing portion S may be formed on three peripheral surfaces of the lower outer shell material 140b that abut the upper outer shell material 140b, and one peripheral surface may be folded. The connection form of the upper outer shell material 140a and the lower outer shell material 140b is not limited to the sealing or folding described above.

Each electrode (anode or cathode) of the electrode assembly 110 is provided with an electrode tab 120, and one or more electrode tabs 120 may be associated with an electrode lead. The electrode leads may function as electrode terminals of the battery cell by being positioned between the sealing portion S of the upper outer shell material 140b and the lower outer shell material 140b and exposed to the outside of the outer shell material 140.

The battery cell described above is illustrated as a pouched type, but this is only an embodiment, and the battery cell may be configured in the form of a cylindrical type, prismatic type, or the like.

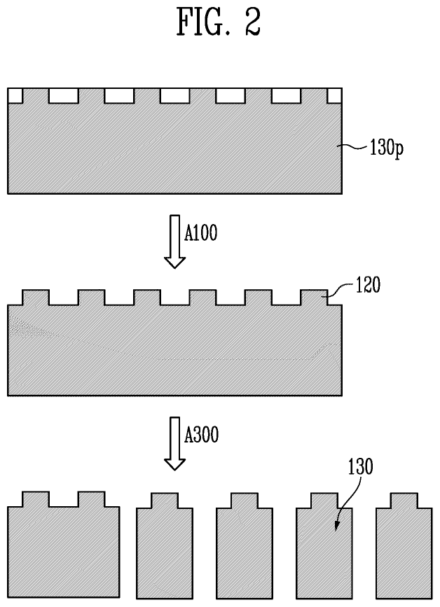

FIG. 2 illustrates a process in which an electrode is manufactured in an electrode manufacturing apparatus of a battery manufacturing system according to an embodiment of the present disclosure. A battery manufacturing system according to the present disclosure may manufacture a battery cell comprising an electrode assembly having a plurality of electrodes stacked thereon, and may include an electrode manufacturing apparatus, a vision device, and an electrode assembly apparatus.

The electrode manufacturing apparatus may manufacture a plurality of electrodes 130 and may include a notching device (not shown) and a cutting device 600 to process electrodes 130 supplied from a roll of electrodes 130.

The notching device may cut a portion of the strip-like pre-electrode 130p to form the electrode tab 120 when the electrode 130 is fed from the roll-like electrode 130 to the strip-like pre-electrode 130p.

The notching device may form the electrode tabs on an uncoated portion of the electrode 130 where the active material is not coated. The strip-like pre-electrode 130p may be divided into an active material coated portion and an uncoated plain portion, and the plain portion may be disposed on one side of the electrode 130.

A notching device may form the electrode tabs 120 by irradiating the plain portion with a laser or pressurizing the mold structure. The notching device may include a laser section to irradiate the plain portion with a laser to form the electrode tabs 120. The notching device may include a mold structure for pressing a mold structure onto the plain portion to form the electrode tab 120.

The notching device may continuously process the plain portion initially formed from the strip-shaped pre-electrode 130p via the laser or mold structure to form the electrode tab 120.

Referring to FIG. 2, in the process A100, the electrode tab 120 may be initially formed from the strip-shaped pre-electrode 130p by a notching device. Before the strip-shaped spare electrodes 130p are cut at predetermined intervals by the cutting device 600, the electrodes 130 may be formed into interconnected strips.

Since the process A100 processes the strip-like pre-electrode 130p through a notching device to form the electrode tab 120, foreign object may be generated that breaks away from the strip-like pre-electrode 130p during the process of forming the electrode tab 120. If the foreign object generated in the process A100 passes through the electrode manufacturing apparatus while disposed on the surface of the electrode 130, it may be detected by the vision device described later.

The cutting device 600 may cut the strip-like pre-electrode 130p in the form of a strip (strap or belt) that has passed through the notching device at predetermined intervals. The cutting device 600 may cut the strip-like pre-electrode 130p to have a width of the predetermined spacing.

The cutting apparatus 600 may cut the strip-like pre-electrode 130p formed by a succession of electrode tabs 120 such that a single electrode tab 120 is formed on a single electrode 130. The cutting device 600 may cut the relatively large-sized strip-like pre-electrode 130p to form multiple units of the electrode 130.

In the process A300, the strip-like pre-electrode 130p formed by a succession of electrode tabs 120 may be cut into multiple units of electrode 130 by the cutting device 600. Since the strip-like pre-electrode 130p is processed through the cutting device 600 in the process A300, foreign object may be generated that falls off the electrode 130 during the processing. If the foreign object generated in the process A300 passes through the electrode manufacturing apparatus while disposed on the surface of the electrode 130, it may be detected by the vision device described later.

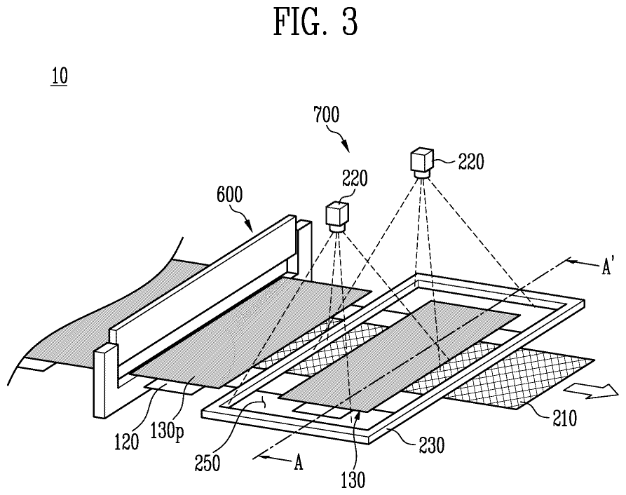

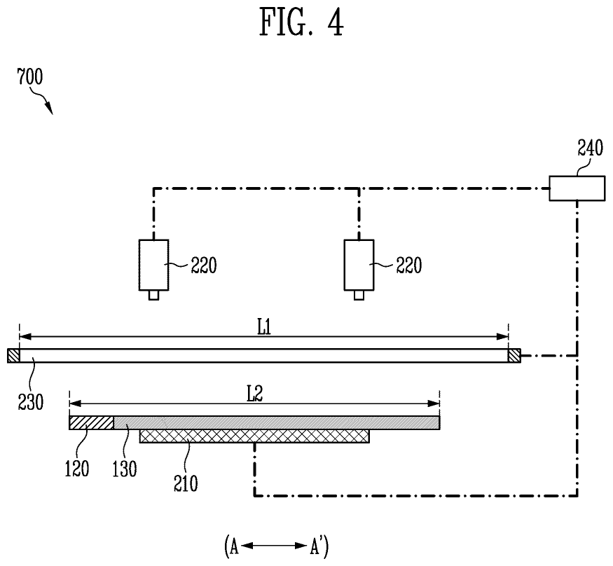

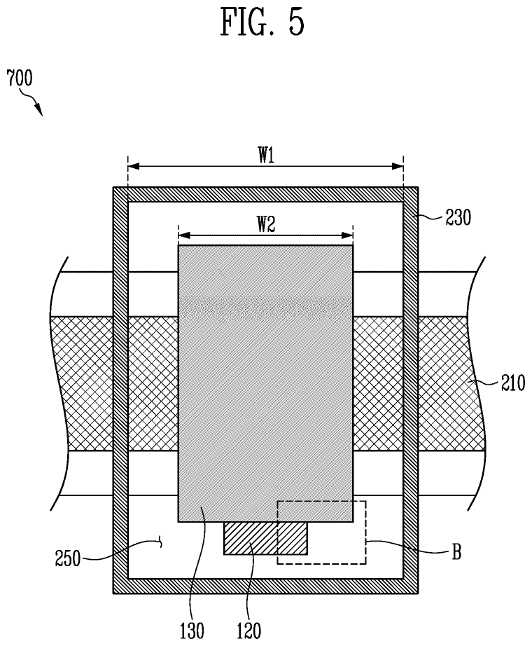

FIG. 3 is a perspective view of a process of inspecting an electrode in a vision device of a battery manufacturing system according to an embodiment of the present disclosure. FIG. 4 is a side view of a process of inspecting an electrode in a vision device of a battery manufacturing system according to an embodiment of the present disclosure. FIG. 5 is a top view of a process of inspecting electrodes in a vision device of a battery manufacturing system according to an embodiment of the present disclosure.

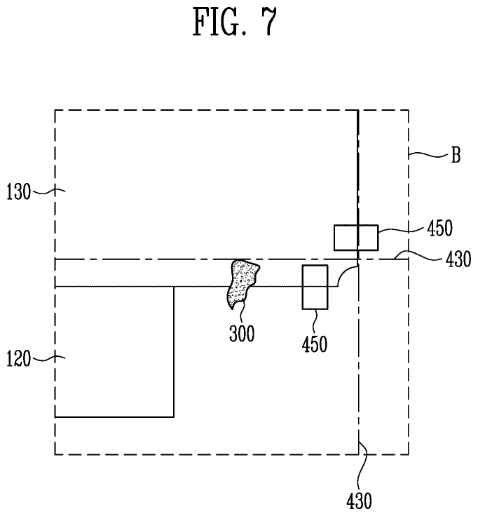

The vision device 700 may shoot an electrode 130 that has been processed by the cutting device 600 into a unit electrode 130 having a single electrode tab 120 formed. The vision device 700 may inspect the foreign object 300 (see FIG. 7) by shooting the electrode 130 processed by the cutting device 600, and the electrode 130 that passes through the vision device 700 may be assembled in the electrode assembly device, and the vision device 700 may be formed between the electrode manufacturing apparatus and the electrode assembly device.

In other words, a battery manufacturing system according to the present disclosure may include an electrode manufacturing apparatus for manufacturing electrodes 130, and a vision device 700 for moving the electrodes 130 manufactured in the electrode manufacturing apparatus through the moving unit 210 and inspecting them through the shooting unit.

In an embodiment, a battery manufacturing system may comprise a vision device 700 for inspecting a foreign object 300 disposed on an electrode 130, wherein the vision device 700 may include: a moving unit 210 supporting the electrode 130 and moving it to a shooting location; a shooting unit 200 positioned above the moving unit 210 and shooting the surface of the electrode positioned at the shooting location; an illuminating unit 230 irradiating light into an illumination region formed larger than shooting location; and a controller 240 analyzing a shot image obtained by the shooting unit 200 and determining and detecting a foreign object 300 disposed on the surface of the electrode 130 when the electrode 130 is positioned in the illumination region.

For example, the battery manufacturing system according to the present disclosure may further include an electrode assembly apparatus for manufacturing an electrode assembly by stacking electrodes 130 that have passed through the vision device 700.

For example, the vision device 700 may include a moving unit 210 that supports and moves the electrode 130, a shooting unit 220 that is positioned above the moving unit 210 and shoots the electrode 130, an illuminating unit 230 that irradiates the electrode 130 with light, and a controller 240 that determines and detects the foreign object 300.

For example, the moving unit 210 supports the electrode 130 and may move the electrode 130 to the shooting location. The moving unit 210 may extend from the electrode manufacturing apparatus and may move a plurality of electrodes 130 manufactured in the cutting apparatus 600 of the electrode manufacturing apparatus.

The moving unit 210 may include a device for continuously moving the plurality of electrodes 130, such as a conveyor belt. The moving unit 210 may be formed with a width that is smaller than the width of the plurality of electrodes 130 disposed on the upper surface.

The plurality of electrodes 130 may be formed with a width extending in a direction perpendicular to the direction of movement that is longer than the width of the moving unit 210, such that the plurality of electrodes 130 may protrude from the moving unit 210 in a direction perpendicular to the direction of movement. The electrode tab 120 may be formed to protrude in a direction perpendicular to the movement direction at one end of the electrode 130, and the electrode tab 120 may be arranged to protrude from the moving unit 210.

The shooting unit 220 is located above the moving unit 210 and may shoot a surface of the electrode 130 disposed at the shooting location. The shooting unit 220 may shoot the surface of the electrode 130 from an upward direction to derive a shot image.

Referring to FIG. 3, a plurality of shooting units 220 are shown, but shooting may be performed with a single shooting unit 220 depending on the performance of the shooting units 220. The shooting location of the shooting unit 220 may correspond to the illumination region formed by the illuminating unit 230.

If a plurality of shooting units 220 is provided, the plurality of shooting units 220 may each shoot an area of the illumination region. The plurality of images taken by the plurality of shooting units 220 may be transmitted to the controller 240 for judgment and detection of the foreign object 300.

The plurality of shooting units 220 may simultaneously or sequentially shoot the surface of the electrode 130, and a plurality of images may be taken of a single electrode 130.

The plurality of shooting units 220 may divide the shooting area over the surface of the electrode 130 to shoot images. The plurality of shooting units 220 may shoot images of the electrode 130 at one end of the electrode 130 where the electrode tab 120 is formed and at the other end of the electrode 130.

The plurality of shooting units 220 may overlap to ensure that each shooting area covers the entire surface of the electrode 130. The plurality of shooting units 220 may include one end and the other end of the electrode 130, and may also shoot between the one end and the other end of the electrode 130.

The shooting unit 220 may be disposed above the illuminating unit 230 so that the surface of the electrode 130 that is illuminated by the illuminating unit 230 may be shot from above, looking down on the surface of the electrode 130.

The illuminating unit 230 may illuminate an illumination region. The illumination region may be an area formed larger than the point of the photograph and encompassed by the illuminating portion 230.

Referring to FIG. 3, the illuminating unit 230 may include a plurality of light sources, and the plurality of light sources may be arranged along a direction of movement of the electrode 130 and a direction perpendicular to the direction of movement, and illuminate the boundary. Some of the plurality of light sources may be disposed perpendicular to each other and connected to form an illumination region.

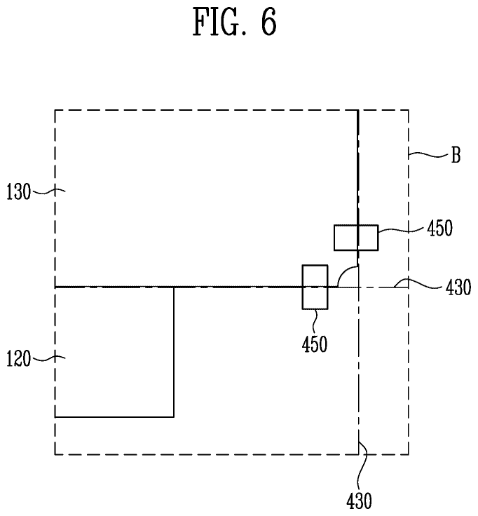

Each of the plurality of light sources may be disposed parallel to an edge of the electrode 130, so as to illuminate a boundary 430 (see FIG. 6) formed by the edges of the electrode 130. The plurality of light sources may irradiate light on the boundary 430 forming an inner region of the electrode 130 to help determine if a foreign object 300 is disposed on the boundary 430, i.e., at least a portion of the boundary 430 may be a portion of the region corresponding to the boundary of the electrode 130.

For example, the plurality of light sources may be formed by a first light to a fourth light. The illuminating unit 230 may include a first light and a second light spaced upwardly from the moving unit 210 and arranged in the direction of movement of the electrode 230, a third light and a fourth light spaced upwardly from the moving unit 210 and arranged in the direction perpendicular to the direction of movement of the electrode 230, and wherein the first, second, third, and fourth lights may be connected to form the illumination region.

For example, the illuminating unit 230 may include a first light and a second light spaced upwardly from the moving unit 210 and disposed in the direction of travel of the electrode 130, and a third light and a fourth light spaced downwardly from the moving unit 210 and disposed perpendicular to the direction of travel of the electrode 130.

The first and second lights may be disposed perpendicular to the third and fourth lights, and may be connected to each other to form an illumination region. The illumination region may be formed larger than the area of the electrode 130 so that the electrode 130 is contained within the illumination region.

In an embodiment, a length between the light sources arranged in the direction perpendicular to the direction of movement is longer than a length of the electrode 130 extending along a direction perpendicular to the direction of movement.

For example, the illuminating unit 230 may be formed such that a length of the light source disposed in a direction perpendicular to the direction of travel is longer than a length of the electrode 130 extending in a direction perpendicular to the direction of movement. FIG. 4 is a cross-sectional view of the illuminating unit 230 and electrode 130 of FIG. 3 with cuts A-A′.

Referring to FIG. 4, a length L1 of a light source disposed in a direction perpendicular to the movement direction in the illuminating unit 230 may be formed longer than a length L2 of the electrode 130 extending in a direction perpendicular to the movement direction.

In the illuminating unit 230, the light source having a length of L1 is formed as a single light source, so that the illuminating unit 230 can irradiate light without forming a shadow in the direction perpendicular to the movement direction.

Referring to FIG. 5, the length W1 of the light source disposed in the moving direction in the illuminating unit 230 may be formed to be longer than the length W2 of the electrode 130 extending in the moving direction.

The light source having a length of W1 in the illuminating unit 230 is formed as a single light source, so that the illuminating unit 230 may irradiate light without forming a shadow in the movement direction.

The illuminating unit 230 is formed in a form that surrounds the electrode 130, so that the surface of the electrode 130 may be irradiated with light as a whole. Referring to FIG. 3, a plurality of light sources may be connected together to form a rectangle, but the shape of the illuminating unit 230 may not be limited thereto.

Further, the illuminating unit 230 may include a lower illuminating unit (not shown) arranged downwardly spaced apart from the moving unit 210. The lower illuminating unit may help to identify the boundary 430 of the electrode 130 by illuminating light at a lower portion of the moving unit 210. The lower illuminating unit may be disposed away from the shooting location of the shooting unit 220 to avoid irradiating light directly onto the shooting unit 220.

The controller 240 may control the shooting unit 220 and the moving unit 210, and may analyze the shooting images obtained through the shooting unit 220. The controller 240 may move the electrode 130 through the moving unit 210 such that the electrode 130 is positioned in the illumination region, and may obtain an image through the shooting unit 220 when the electrode 130 is positioned in the illumination region.

FIG. 6 illustrates identifying the boundaries of an electrode in a vision device of a battery manufacturing system according to an embodiment of the present disclosure, FIG. 7 illustrates a vision device of a battery manufacturing system according to an embodiment of the present disclosure showing a foreign object disposed at the boundary of an electrode. FIGS. 6 and 7 are illustrative drawings to describe a process in which a controller 240 determines a boundary for the region B in FIG. 5.

The controller 240 may determine and detect a foreign object 300 disposed on the surface of the electrode 130 when the electrode 130 is positioned in the illumination region by analyzing an image obtained by the shooting unit 220 shooting the electrode 130.

In an embodiment, the controller 240, before determining whether the foreign object 300 is disposed on the surface of the electrode 130, analyzes the shot image to determine a boundary of the shape of the electrode surface.

For example, prior to determining the foreign object 300 disposed on the surface of the electrode 130, the controller 240 may analyze the shot image to determine a boundary 430 for the shape of the surface of the electrode 130. By determining the boundary 430 of the electrode 130, the controller 240 may determine an inner region of the electrode 130.

Because the plurality of electrodes 130 disposed in the illumination region may be disposed at different angles, the controller 240 may determine the boundary 430 of the electrodes 130 prior to determining whether the foreign object 300 is disposed.

The controller 240 may determine the boundary 430 of the electrode 130 by analyzing a shot image by the shooting unit 220 of the electrode 130 in an illumination region, and may display the determined boundary 430 as a line. When the controller 240 determines the boundary 430, the length and area of the inner region of the electrode 130 corresponding to the interior of the boundary 430 is also determined.

The controller 240 may determine that a foreign object 300 is disposed at the boundary 430 if the area of the inner region of the electrode 130 measured through the determination of the boundary 430 differs from the design value of the electrode 130.

The controller 240 may determine that a foreign object 300 is disposed at the boundary 430 when a length in the direction of movement of the electrode 130 and a length in a direction perpendicular to the direction of movement of the electrode 130 with respect to the inner region of the electrode 130 is different from the design value and the boundary value (meaning a length corresponding to the drawing symbol 450 in FIG. 6, hereinafter referred to using the drawing symbol 450), respectively.

If the foreign object 300 is disposed on the boundary 430 of the electrode 130, the controller 240 may confuse the foreign object 300 with the boundary 430 of the electrode 130. The controller 240 may determine that a foreign object 300 is disposed at the boundary 430 by comparing the design value for the inner region of the electrode 130 to the measured length of the inner region.

For example, the boundary value 450 may correspond to a length of 3 mm. The controller 240 may determine that a foreign object 300 is disposed at the boundary 430 of the electrode 130 if the measured length of the inner region differs by more than 3 mm from a design value for the inner region of the electrode 130. The boundary value 450 may be set to a predetermined length, and is not limited to 3 mm.

The controller 240 may then determine that the foreign object 300 is disposed in an inner region of the electrode 130 corresponding to the interior of the boundary 430 of the electrode 130. In an embodiment, the controller 240 derives an inner region image of an inner region of the electrode 130 corresponding to an interior of the boundary from the shot image, and determines whether the foreign object 300 is disposed in the inner region image. For example, the controller 240 may derive an inner region image of the inner region of the electrode 130, and may determine whether the foreign object 300 is disposed in the inner region from the inner region image.

The controller 240 may convert the pixels of the inner region image into a numerical value, and determine that the foreign object 300 is disposed in a pixel having a reference value or higher among the pixels. The pixels of the inner region image may be converted to a brightness color or a numerical value of brightness, and a comparison to the reference value may determine a location where the foreign object 300 is disposed in the inner region of the electrode 130.

If the foreign object 300 is not disposed on the surface of the electrode 130, the pixels in the inner region image may have similar values. The pixels of the inner region image may have a constant value, and the pixel region where the foreign object 300 is disposed may have a larger or smaller value compared to the constant value due to the foreign object 300. The pixel in which the foreign object 300 is disposed may have a large deviation from the constant value.

A pixel may be determined to have a foreign object 300 if the pixel is larger or smaller than a reference value, depending on the numerical conversion setting. The foreign object 300 may be determined to be placed when the pixel is larger than the reference value, i.e., the pixel in which the foreign object 300 is placed may be larger than the reference value.

When the foreign object 300 is disposed on the surface of the electrode 130, the pixel where the foreign object 300 is disposed in the inner region image may have a larger value. The pixels in the inner region image may be converted to a numerical value for brightness or RGB.

The controller 240 may select pixels in the inner region image that are above a reference value and determine that the pixel has a foreign object 300 disposed therein. The controller 240 may distinguish the foreign object 300 from the surface of the electrode 130 by adjusting the brightness or contrast of pixels having the reference value or higher, and determines an area of the appearance of the foreign object 300.

The controller 240 may emphasize the contour or shape of the foreign object 300 disposed on the surface of the electrode 130. The controller 240 may adjust the contrast of pixels that are above a reference value to clearly identify the foreign object 300.

For example, the controller 240 may increase the contrast of pixels having a reference value or higher to distinguish the foreign object 300 from the surface of the electrode 130. The controller 240 may determine the shape of the distinguished foreign object 300 to calculate the size of the foreign object 300.

If the controller 240 is configured in the form of a loop with a closed area of the foreign object 300 such that the size may be calculated, the controller 240 may compare the area of the foreign object 300 to the detection value (the area of portion 410 in FIG. 7) to determine if the foreign object 300 is an object to be detected.

If the foreign object 300 is not organized in the form of a loop, the controller 240 may calculate the size of the pixel in which the foreign object 300 is disposed and determine that it is a detection target if it is disposed above a preset reference value (e.g., 1200 pixels).

The controller 240 may adjust the brightness or contrast of the pixels to distinguish between foreign objects 300 disposed on the surface of the electrode 130 and the surface of the electrode 130.

In an embodiment, the controller 240 may determine that the foreign object 300 is a target for detection when the area of the appearance of the foreign object 300 is equal to or higher than a detection value.

For example, the controller 240 may measure the number of pixels or the area occupied by an outline of the foreign object 300, and may determine that the foreign object 300 is an object to be detected if the number is greater than or equal to a detection value 410.

In an embodiment, the detection value 410 corresponds to an area formed by 5 mm in width and 5 mm in length.

For example, the detection value 410 may correspond to an area formed by 5 mm across and 5 mm long.

The controller 240 may seek to detect foreign objects 300 that occupy more than an area formed by 5 mm across and 5 mm long, but the foreign objects 300 may not be detected only in a square shape.

To detect the foreign object 300, which may have an irregular shape, the controller 240 may measure the number or area of pixels containing the outline of the foreign object 300. The controller 240 may determine that the foreign object 300 is a target for detection if the number of pixels containing the shape of the foreign object 300 is greater than or equal to 1200 pixels or greater than or equal to an area formed by a width of 5 mm and a length of 5 mm.

Thus, the controller 240 may not determine the foreign object 300 as a target to be detected if the foreign object 300 is disposed on the surface of the electrode 130 even if the foreign object 300 is smaller than the detection value 410. The controller 240 may determine that the foreign object 300 smaller than the detection value 410 is not disposed as a factor that does not affect the performance of the battery.

For example, the controller 240 may determine that a foreign object 300 is not disposed at the boundary 430 of the electrode 130 if the difference between the measured length of the inner region of the electrode 130 and the design value is less than a boundary value 450 of 3 mm. If approximately 4 mm of foreign object 300 is disposed on the boundary 430 of the electrode 130, the controller 240 may determine that foreign object 300 is disposed on the boundary 430.

The perimeter 430 may be varied by the foreign object 300, and the inner side of the perimeter 430 may be treated as the inner region. The controller 240 may determine that the foreign object 300 is disposed on the surface of the electrode 130 if a pixel in the image of the inner region has a reference value or higher.

Since the controller 240 may determine that the foreign object 300 is disposed at the boundary 430, but cannot determine its exact location, the controller 240 may utilize the inner region image, which is the inner side of the boundary 430. As previously described, the controller 240 may compare pixels in the inner region image to a reference value to determine the exact location of the foreign object 300 disposed at the boundary 430.

Even if the controller 240 confirms the location of the foreign object 300 disposed at the boundary 430, the controller 240 may not determine the foreign object 300 to be a target object if the area of the foreign object 300 is measured to be smaller than the area formed by the detection value 410 of 5 mm across and 5 mm long.

In other words, if the area of the outer shape of the foreign object 300 is measured to be smaller than the predetermined area of the detection value 410, the controller 240 may not determine the foreign object 300 as an object to be detected.

Referring to FIG. 6, the controller 240 is in the process of determining the boundary 430 of a first edge portion of the electrode 130, wherein the first edge of the electrode 130 is damaged. The controller 240 may determine and finalize the boundary 430 by analyzing the shot image of the electrode 130 by the shooting unit 220.

In FIG. 6, the controller 240 determines the boundary 430 separating the inner region of the electrode 130 from the outer region and marks it with a line. After determining the boundary 430, the controller 240 may determine if the foreign object 300 is disposed on the boundary 430.

In an embodiment, the controller 240 may determine that the foreign object 300 is disposed at the boundary 430 when a length of a direction of movement of the electrode 130 and a length of a direction perpendicular to the direction of movement of the electrode 130 with respect to an inner region of the electrode 130 differs by more than a design value and a boundary value 450.

For example, the controller 240 may determine that a foreign object 300 is disposed at the boundary 430 when the length of the direction of movement of the electrode 130 and the length of the direction perpendicular to the direction of movement of the electrode 130 with respect to the inner region of the electrode 130 are each greater than or equal to the design value and the boundary value 450.

In FIG. 6, one edge of the electrode 130 may be damaged, causing the length of the inner region of the electrode 130 to differ from the design value. In FIG. 6, the length of the damaged portion at the corner of the electrode 130 is measured to be less than the boundary value 450, which may cause the controller 240 to determine that the foreign object 300 is not disposed at the boundary 430.

The controller 240 may assume the shape of the hypothetical electrode 130 along the design value and continuously check the boundary value 450 along the boundary of the hypothetical electrode 130.

The controller 240 may determine the boundary 430 of the electrode 130 by checking the plurality of boundary value 450.

The controller 240 may measure the length of the inner region of the electrode 130 even when the length of the inner region of the electrode 130 is reduced due to damage to the electrode 130, and may determine if the electrode 130 is within tolerance of the design values.

In FIG. 7, the controller 240 misjudged the boundary 430 of the electrode 130 due to a foreign object 300 disposed at the boundary 430. Therefore, the length of the inner region of the electrode 130 measured by the controller 240 may differ from the design value.

The controller 240 may form the boundary 430 of the electrode 130 inwardly than the actual boundary 430, causing the inner region of the electrode 130 to be smaller than the design value of the electrode 130.

The length of the inner region of the electrode 130 measured by the controller 240 may differ from the design value of the electrode 130 by more than the boundary value 450. In FIG. 7, the length of the inner region of the electrode 130 measured by the controller 240 may differ by more than 3 mm from the design value and the boundary value 450, such that the controller 240 may determine that a foreign object 300 is disposed at the boundary 430.

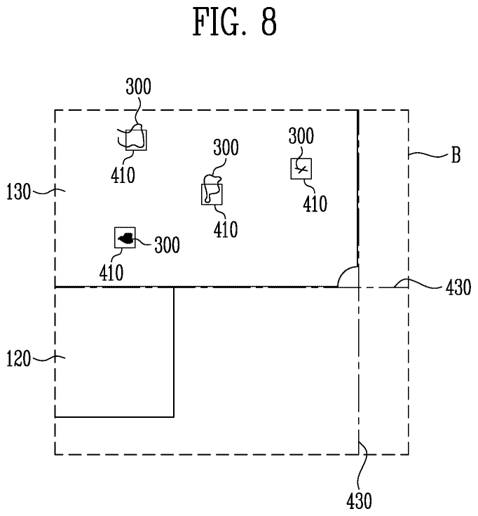

FIG. 8 illustrates a foreign object disposed in an inner region of an electrode in a vision device of a battery manufacturing system according to an embodiment of the present disclosure. FIG. 8 illustrates a process in which the controller 240 analyzes an image shot by the shooting unit 220 of the area B in FIG. 5.

The controller 240 has determined that the foreign object 300 is not disposed at the boundary 430 and has determined the boundary 430. The controller 240 may derive an inner region image of the inner region of the electrode 130, which is the interior of the boundary 430, and determine whether a foreign object 300 is disposed therein.

In FIG. 8, a plurality of foreign objects 300 of different sizes and shapes are disposed in the inner region of the electrode 130. The controller 240 may numerically count pixels in the image of the inner region of the electrode 130, and determine that a foreign object 300 is disposed in a pixel having a value above a reference value.

In FIG. 8, the controller 240 may determine that four foreign objects 300 are disposed by numerically converting the pixels in the image of the inner region of the electrode 130. The controller 240 may adjust the brightness or contrast of the pixels in which the four foreign objects 300 are disposed to determine the area of the appearance of the foreign objects 300.

The four foreign objects 300 may have various shapes, such as a ring, a band, or the like, and the controller 240 may measure the number of pixels or the area of the pixels occupied by the area of the foreign objects 300.

If the number of pixels or area occupied by the area of the outline of the foreign object 300 is greater than or equal to the detection value 410, the controller 240 may determine that the foreign object 300 is an object to be detected.

The controller 240 may determine that two of the foreign objects 300 having a reference value or higher among the four foreign objects 300 shown in FIG. 8 are to be detected, and may not detect the remaining two foreign objects 300 that are formed smaller than the reference value.

The controller 240 may determine that four foreign objects 300 are disposed in the inner region of the electrode 130 by numerically converting the pixels of the image of the inner region of the electrode 130, but may selectively determine whether to detect the foreign objects 300 based on the area occupied by the foreign objects 300.

The controller 240 may provide an alarm for the foreign object 300 that is determined to be a target for detection, or may trigger further processes to remove the foreign object 300.

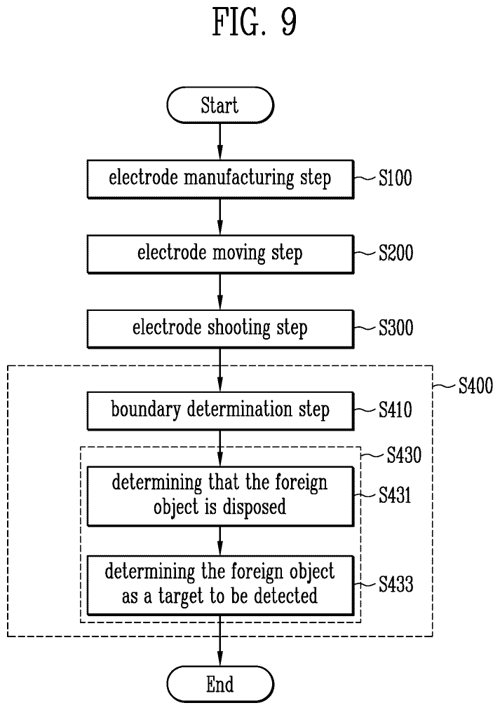

FIG. 9 is a flow chart illustrating a battery manufacturing method according to an embodiment of the present disclosure.

A battery manufacturing method according to the present disclosure may include an electrode manufacturing step S100, an electrode moving step S200, an electrode shooting step S300, and a foreign object detection step S400.

In an embodiment, a battery manufacturing method S100 may a step S200 of moving the electrode 130 through the moving unit 210 to position the electrode 130 in an illumination region, a step S300 of shooting the electrode 130 through the shooting unit to obtain a shot image of the electrode, and a step S400 of detecting a foreign object on a surface of the electrode based on the shot image.

For example, a battery manufacturing method according to the present disclosure may include a step S100 of manufacturing an electrode 130 in an electrode manufacturing apparatus, a step S200 of moving the electrode 130 through a moving unit 210 to position the electrode 130 in an illumination region, a step S300 of shooting the electrode through a shooting unit to obtain a shot image of the electrode, and a step S400 of detecting a foreign object on a surface of the electrode based on the shot image.

The battery manufacturing method according to the present disclosure may manufacture a plurality of electrodes 130 via an electrode manufacturing apparatus in an electrode manufacturing step S100.

The battery manufacturing method according to the present disclosure may manufacture a plurality of electrodes 130 through a notching device (not shown) and a cutting device 600 included in the electrode manufacturing apparatus in the electrode manufacturing step S100.

That is, the electrode manufacturing step S100 may include the step of forming the electrode tabs 120 on the strip-like pre-electrode 130p supplied from the roll-shaped electrode through the notching device, and the step of cutting the strip-like pre-electrode 130p formed by the electrode tabs 120 that have passed through the notching device through the cutting device 600 at a predetermined interval.

The battery manufacturing method according to the present disclosure may, in an electrode movement step S200, position a plurality of electrodes 130 manufactured in the electrode manufacturing step S100 in an illumination region via a moving unit 210. The illumination region may be formed by an illuminating unit 230, and the illuminating unit 230 may include a plurality of light sources.

The plurality of light sources may each be disposed parallel to an edge of the electrode 130, so as to illuminate a boundary 430 formed by the edges of the electrode 130. The length of the plurality of light sources may be formed to be longer than the length of each edge of the opposing electrodes 130 and may be connected to each other to form an illumination region.

The electrode moving step S200 may be a preparation step for shooting the electrodes 130 by positioning one of the plurality of electrodes 130 in the illumination region via the moving unit 210.

The battery manufacturing method according to the present disclosure may obtain an image by shooting the plurality of electrodes 130 through the shooting unit 220 in the electrode shooting step S300. The electrode shooting step S300 may obtain the shot image by shooting the electrodes 130 disposed in the illumination region from above.

The electrode shooting step S300 may be performed through a plurality of shooting units 220, and depending on the size of the electrode 130, shooting may be performed through some of the plurality of shooting units 220.

After the electrode shooting step S300, the battery manufacturing method according to the present disclosure may include a foreign object detection step S400 to detect foreign objects in contact with or attached to the electrode 300 in the imaged images obtained in the electrode shooting step S300.

The foreign object detection step S400 may include a boundary determination step S410 and a foreign object determining step S430.

A battery manufacturing method according to the present disclosure may recognize a boundary 430 for the shape of the surface of the electrode 130 by analyzing the imaged image in a boundary determination step S410. The boundary determination step S410 may identify a boundary 430 in the shot image that separates an inner region of the electrode 130 from an exterior region of the electrode 130.

The battery manufacturing method according to the present disclosure may determine the boundary 430 of the electrode 130 in the boundary determination step S410 to determine an inner region of the electrode 130 that is inside the boundary 430 of the electrode 130. The boundary determination step S410 may determine the boundary 430 of the electrode 130 by analyzing an image shot of the electrode 130 by the shooting unit 220 in the illumination region, and may mark the determined boundary 430 with a line. When the boundary determination step S410 determines the boundary 430, the length and area of the inner region of the electrode 130 corresponding to the interior of the boundary 430 is also determined.

The boundary determination step S410 may be a preparatory step to establish a region for determining the foreign object 300 in the foreign object determination step S430.

The foreign object determination step S430 may determine and detect the foreign object 300 disposed on the surface of the electrode 130.

The foreign object determining step S430 may include a step of determining whether the foreign object 300 is disposed on the surface of the electrode 130 and a step of determining whether the foreign object 300 determined to be disposed in the determining step is detected.

In an embodiment, the step of detecting a foreign object may include a step of determining S400 whether the foreign object 300 is disposed based on a pixel number value of an image of an inner region of a boundary 430 of a shape of the electrode 130 surface obtained from the shot image, and a step S433 of determining, if the foreign object 300 is disposed, the foreign object 300 is a target for detection based on the brightness or contrast of the image of the inner region.

For example, a battery manufacturing method according to the present disclosure may include, in a step S400 of detecting a foreign object on a surface of the electrode, a step S431 of determining that the foreign object 300 is disposed based on a pixel count of an image of an inner region of a boundary 430 of a shape of the surface of the electrode 130 obtained from an image, and a step S433 of determining that the foreign object 300 is an object to be detected based on a brightness or contrast of the image of the inner region when the foreign object 300 is determined to be disposed.

Specifically, the battery manufacturing method according to the present disclosure may include a step S430 of determining the foreign object, deriving an inner region image corresponding to the interior of the boundary 430 from the shot image, converting the pixels of the inner region image to a numerical value, and determining that the foreign object 300 is disposed in a pixel having a reference value or higher among the pixels, and a step S431 of determining that the foreign object 300 is disposed in the pixel.

Then, the battery manufacturing method according to the present disclosure may further include a step S430 of determining the area of the appearance of the foreign object 300 by adjusting the brightness or contrast of the pixel having the reference value or higher when judging that the foreign object 300 is disposed in the foreign object determining step S433, and judging the foreign object 300 as an object to be detected when the area of the appearance of the foreign object 300 is equal to or greater than the detection value 410.

More specifically, the battery manufacturing method according to the present disclosure may determine that the foreign object 300 is disposed in an inner region of the electrode 130 corresponding to an interior of the perimeter 430 of the electrode 130 in the step of determining that the foreign object 300 is disposed S431. If the foreign body 300 is disposed on the surface of the electrode 130, the pixels where the foreign body 300 is disposed in the inner region image may be significantly enlarged.

In a step S431 of determining that a foreign object 300 is disposed, the battery manufacturing method according to the present disclosure may select a pixel in the inner region image that has a value above a reference value and determine that the foreign object 300 is disposed in the pixel.

When the foreign object 300 is disposed on the electrode 130, it may be disposed on the electrode 130 boundary 430 or in the inner region of the electrode 130.

In an embodiment, the step S431 of determining whether the foreign object 300 is disposed includes a step of determining that the foreign object 300 is disposed at the boundary 430 when the difference between a length of the electrode 130 measured based on the pixel number value of the image of the inner region and a design number value is equal to or higher than a boundary number value 450.

For example, the battery manufacturing method according to the present disclosure may determine that the foreign object 300 is disposed at the boundary 430 when, in the step S431 of determining that the foreign object 300 is disposed, the difference between the length of the electrode 130 measured based on the pixel value (number of pixels or pixel value) of the image of the inner region and the design value is greater than or equal to the boundary value 450.

Specifically, the battery manufacturing method according to the present disclosure may determine the boundary 430 with respect to the shape of the surface of the electrode 130 by analyzing the shot image in the boundary determination step S410, and in the step of determining that the foreign object 300 is disposed, it may be determined whether the foreign object 300 is disposed at the boundary 430 of the electrode 130 or whether the foreign object 300 is disposed in an internal region of the electrode 130.

In the step of determining the foreign object 300 to be detected, the battery manufacturing method according to the present disclosure may determine the foreign object 300 to be detected as a foreign object that occupies an area formed by 5 mm across and 5 mm long.

In the step S433 of determining the foreign object 300 as a target to be detected, the battery manufacturing method according to the present disclosure may determine the foreign object 300 as a target to be detected if the foreign object 300 has an irregular shape and the number of pixels containing the appearance of the foreign object 300 is 1200 pixels or more.

The battery manufacturing method according to the present disclosure may determine that the foreign object 300 is disposed at the boundary 430 when the size of the inner region image is different from the design value and the boundary value 450 or more in the step S431 of determining that the foreign object 300 is disposed.

In the step S431 of determining that the foreign object 300 is disposed, the battery manufacturing method according to the present disclosure may determine whether the foreign object 300 is disposed at the boundary 430 of the electrode 130 or in the inner region of the electrode 130.

In other words, the battery manufacturing method according to the present disclosure may determine that the foreign object 300 is disposed at the boundary 430 when, in the step of determining that the foreign object 300 is disposed, the length of the direction of movement of the electrode 130 and the direction perpendicular to the direction of movement of the electrode 130 with respect to the inner region of the electrode 130 is different from the design value and the boundary value 450, respectively.

The boundary value 450 may correspond to a length of 3 mm. The step of determining that a foreign object 300 is disposed may determine that a foreign object 300 is disposed at the boundary 430 of the electrode 130 when the length of the measured inner region differs by more than 3 mm from a design value for the inner region of the electrode 130.

In an embodiment, the step S431 of determining whether the foreign object 300 is disposed may include a step of determining that the foreign object is disposed in the inner region when pixel number value is equal to or higher than a preset reference value based on the pixel number value of the image of the inner region.

For example, in the step S431 of determining that a foreign object 300 is disposed, the battery manufacturing method according to the present disclosure may determine that a foreign object 300 is disposed in the inner region when the pixel count is above a predetermined reference value based on the pixel count of an image of the inner region.

For example, if the transverse and longitudinal lengths of the electrode 130 differ by 3 mm or more between the design value of the electrode 130 and the boundary value 450, the foreign object 300 may be determined to be disposed at the boundary 430 of the electrode 130.

If the foreign object 300 is disposed on the boundary 430 of the electrode 130, the size of the inner region of the electrode 130 may be determined to be smaller or larger depending on the disposition of the foreign object 300.

Whether the foreign object 300 is disposed in the inner region of the electrode 130 may be determined by converting the pixels of the inner region image to a numerical value, and if the converted value is greater than or equal to a predetermined reference value, the foreign object 300 is disposed in the corresponding pixel.

In the above judgment process, the foreign object 300 disposed at the boundary 430 of the electrode 130 may also be judged to be disposed by numerical conversion.

By adjusting the brightness or contrast of the pixel in which the foreign object 300 is disposed, the size of the foreign object 300 may be calculated by clarifying the distinction between the foreign object 300 and the surface of the electrode 130.

In an embodiment, the step S433 of determining whether the foreign object is disposed may include a step of calculating a size of the foreign object 300 disposed in the inner region or at the boundary 430 based on the brightness or contrast of the image of the inner region and a step of determining the foreign object 300 as a target for detection when the calculated size is higher than a preset detection value 410 or the preset reference value.

For example, the battery manufacturing method according to the present disclosure may, in the step S433 of determining the foreign object to be detected, calculate the size of the foreign object 300 disposed in the inner region or the boundary 430 based on the brightness or contrast of the image of the inner region, and determine the foreign object 300 to be detected when the calculated size is greater than the preset detection value 410 or the reference value.

When the size of the foreign object 300 is configured in the form of a loop with a closed area, the foreign object 300 may be determined to be a target for detection by comparing the size of the foreign object 300 with the detection value 410. If the size of the foreign object 300 is not configured in the form of a loop, the foreign object 300 may be determined to be a target for detection by comparing the detection value with a predetermined threshold number of pixels instead of the detection value.

On the other hand, even if the foreign object 300 is determined to be disposed in the inner region, the foreign object 300 may not be subject to detection through comparison with the detection value 410 or the reference value.

Alternatively, if the transverse and longitudinal lengths of the electrode 130 do not differ by more than 3 mm between the design value of the electrode 130 and the boundary value 450, it may be determined that the foreign object 300 is not disposed at the boundary 430 of the electrode 130. As described above, the determination of placement of the foreign object 300 and the determination of detection of the foreign object 300 may proceed in the same manner as in the case where the foreign object 300 is disposed on the boundary 430.

The battery manufacturing method according to the present disclosure may, upon determining the foreign object 300, notify the user of an alarm, or remove the electrode 130 on the moving unit 210 where the foreign object 300 is detected.

The present disclosure is not limited to the embodiments described above, and may include combinations of the above embodiments or combinations of at least one of the above embodiments with known techniques as other embodiments.

While the present disclosure has been described in detail with specific embodiments, it is intended to illustrate the present disclosure in detail and not to limit it, and it will be apparent that modifications and improvements may be made by those having ordinary skill in the art within the technical ideas of the present disclosure.

All simple variations or modifications of the present disclosure are within the scope of the present disclosure, and the specific scope of protection of the present disclosure will be made clear by the appended patent claims.

What is claimed is:

1. A battery manufacturing system, comprising:
a vision device for inspecting a foreign object disposed on an electrode,
wherein the vision device includes: a moving unit supporting the electrode and moving it to a shooting location; a shooting unit positioned above the moving unit and shooting the surface of the electrode positioned at the shooting location; an illuminating unit irradiating light into an illumination region formed larger than shooting location; and a controller analyzing a shot image obtained by the shooting unit and determining and detecting a foreign object disposed on the surface of the electrode when the electrode is positioned in the illumination region.

2. The battery manufacturing system according to claim 1, wherein the controller, before determining whether the foreign object is disposed on the surface of the electrode, analyzes the shot image to determine a boundary of the shape of the electrode surface.

3. The battery manufacturing system according to claim 2, wherein the illuminating unit includes a plurality of light sources and the plurality of light sources are arranged along a direction of movement of the electrode and a direction perpendicular to the direction of movement, and illuminate the boundary.

4. The battery manufacturing system according to claim 3, wherein a length between the light sources arranged in the direction perpendicular to the direction of movement is longer than a length of the electrode extending along a direction perpendicular to the direction of movement.

5. The battery manufacturing system according to claim 2, wherein the controller derives an inner region image of an inner region of the electrode corresponding to an interior of the boundary from the shot image, and determines whether the foreign object is disposed in the inner region image.

6. The battery manufacturing system according to claim 5, wherein the controller converts the pixels of the inner region image into numeral values, and determines that the foreign object is disposed in a pixel having a reference value or higher among the pixels.

7. The battery manufacturing system according to claim 6, wherein the controller distinguishes the foreign object from the surface of the electrode by adjusting the brightness or contrast of pixels having the reference value or higher, and determines an area of the appearance of the foreign object.

8. The battery manufacturing system according to claim 7, wherein the controller determines that the foreign object is a target for detection when the area of the appearance of the foreign object is equal to or higher than a detection value.

9. The battery manufacturing system according to claim 8, wherein the detection value corresponds to an area formed by 5 mm in width and 5 mm in length.

10. The battery manufacturing system according to claim 2, wherein the controller determines that the foreign object is disposed at the boundary when a length of a direction of movement of the electrode and a length of a direction perpendicular to the direction of movement of the electrode with respect to an inner region of the electrode differs by more than a design value and a boundary value.

11. The battery manufacturing system according to claim 10, wherein the boundary value corresponds to a length of 3 mm.

12. The battery manufacturing system of claim 3, wherein the illuminating unit includes:
a first light and a second light spaced upwardly from the moving unit and arranged in the direction of movement of the electrode;
a third light and a fourth light spaced upwardly from the moving unit and arranged in the direction perpendicular to the direction of movement of the electrode; and
wherein the first, second, third, and fourth lights are connected to form the illumination region.

13. The battery manufacturing system according to claim 1, wherein the shooting unit is provided in plural and the plurality of the shooting units each shoot an area of the illumination region.

14. The battery manufacturing system according to claim 1, wherein the illuminating unit includes a lower illuminating unit arranged downwardly spaced apart from the moving unit.

15. A battery manufacturing method using a battery manufacturing system including a vision device moving an electrode through a moving unit and inspecting it through a shooting unit, the method comprising:
a step of moving the electrode through the moving unit to position the electrode in an illumination region;
a step of shooting the electrode through the shooting unit to obtain a shot image of the electrode; and
a step of detecting a foreign object on a surface of the electrode based on the shot image.

16. The battery manufacturing method according to claim 15, wherein the step of detecting a foreign object includes:
a step of determining whether the foreign object is disposed based on a pixel number value of an image of an inner region of a boundary of a shape of the electrode surface obtained from the shot image; and
a step of determining, if the foreign object is disposed, the foreign object is a target for detection based on the brightness or contrast of the image of the inner region.

17. The battery manufacturing method according to claim 16, wherein the step of determining whether the foreign object is disposed includes a step of determining that the foreign object is disposed at the boundary when the difference between a length of the electrode measured based on the pixel number value of the image of the inner region and a design number value is equal to or higher than a boundary number value.

18. The battery manufacturing method according to claim 17, wherein the step of determining whether the foreign object is disposed includes a step of determining that the foreign object is disposed in the inner region when pixel number value is equal to or higher than a preset reference value based on the pixel number value of the image of the inner region.

19. The battery manufacturing method according to claim 18, wherein the step of determining whether the foreign object is disposed includes a step of calculating a size of the foreign object disposed in the inner region or at the boundary based on the brightness or contrast of the image of the inner region and a step of determining the foreign object as a target for detection when the calculated size is higher than a preset detection value or the preset reference value.
